(19) United States
(12) Patent Application Publication
(10) Pub. No.: US 2009/0061378 A1
(43) Pub. Date: Mar. 5, 2009

(54) ORTHODONTIC WIRE AND MANUFACTURING METHOD THEREOF

(75) Inventors: In-Jae Kim, Gyeonggi-do (KR); Sang-Gi Kim, Gyeonggi-do (KR); Seung-Jae Park, Daegu City (KR); Ji-Hun Jung, Seoul (KR); Chang-Seob Han, Gyeonggi-do (KR); Seong-Chul Shin, Gyeonggi-do (KR)

Correspondence Address: CANTOR COLBURN, LLP, 20 Church Street, 22nd Floor, Hartford, CT, 06103, US

(73) Assignee: In-Jae KIM, Gunpo City (KR)

(21) Appl. No.: 12/159,522

(22) PCT Filed: Dec. 22, 2006
(86) PCT No.: PCT/KR06/05643

§ 371 Date: Jun. 27, 2008

(30) Foreign Application Priority Data
Dec. 27, 2005 (KR) 10-2005-0130699
Jun. 12, 2006 (KR) 10-2006-0052685
Sep. 6, 2006 (KR) 10-2006-0085682

(51) Int. Cl. A61C 7/20; B21F 43/00

(52) U.S. Cl. 433/20; 29/896.11

(57) ABSTRACT

The present invention relates to an orthodontic wire and a manufacturing method thereof, and more particularly, to an orthodontic wire, which is not harmful to the human body and is capable of continuously holding the color of teeth, and a manufacturing method of the orthodontic wire. According to the present invention, there is provided an orthodontic wire, comprising a metal wire formed of a shape memory alloy material; a silver (Ag) film applied to a surface of the metal wire; and a polymer compound film applied to a surface of the silver (Ag) film to prevent the silver (Ag) film from being discolored.

### TECHNICAL FIELD

The present invention relates to an orthodontic wire and a manufacturing method thereof, and more particularly, to an orthodontic wire, which is not harmful to the human body and is capable of continuously holding the color of teeth, and a manufacturing method of the orthodontic wire.

### BACKGROUND ART

For instance, as periodontal tissue is sequentially destructed from a gingival edge by progression of periodontitis and thus alveolar bone is gradually lost. Accordingly, the phenomenon that a tooth in which the periodontitis occurs is shaken, i.e., symptoms of a so-called pyorrhea, appears. As a method for treating a tooth in pyorrhea, there is a method for fixing a tooth, which is shaken but worth being preserved, together with adjacent teeth, which are less shaken, although a tooth, which is severely shaken and thus is not worth being preserved, is pulled out.

A metal wire is generally used for fixing a plurality of adjacent teeth. According to such a method, a metal wire is wound around a plurality of teeth to be fixed using elasticity of the metal wire, and a load generated by bending or tension of the metal wire is applied to the teeth, thus fixing the teeth by the load.

The foregoing method has problems in that the man-hour is required in a work for sequentially winding and adhering the metal wire around and to the teeth to be fixed, a patient always feels a pain due to the applied load and suffers from displeasure, and the metal wire catches the eyes of other persons in front of the patient when the patient opens his or her mouth, which does not look fine externally.

Therefore, methods for fixing a set of teeth using shape memory alloy have recently been suggested. In such methods, a wire-shaped correction member made of shape memory alloy is heat treated such that a shape in a parent phase state previously becomes a desired shape, i.e. a shape with an automatically straight set of teeth, the correction member is installed corresponding to a set of teeth of a patient at low temperature, the correction member is heated restored to its original shape, and the set of teeth are corrected by the elasticity of the correction member.

FIG. 1 shows a schematic view and a sectional view of a conventional orthodontic wire.

As shown in FIG. 1 (a), an orthodontic wire 10 is externally similar to an ordinary wire. However, since the orthodontic wire 10 is internally different from an ordinary wire, a shape and a manufacturing process of the orthodontic wire 10 will simply be described with reference to FIG. 1 (b).

FIG. 1 (b) is a sectional view of a portion “A” of the orthodontic wire shown in FIG. 1(a).

As shown in FIG. 1 (b), the conventional orthodontic wire 10 comprises a metal wire 11 and a Teflon coating film 13 formed on the surface of the metal wire 11. The metal wire 11 may be an ordinary metal wire or a metal wire made of shape memory alloy. The Teflon coating film 13 is applied and formed on the surface of the metal wire 11 by a variety of coating methods. The Teflon coating film 13 is applied to have a color similar to that of teeth.

As described in the above, an orthodontic wire has conventionally been formed by coating a surface of a metal wire with a Teflon coating film in order to represent the color of teeth. However, the Teflon has been causing a trouble due to controversy of its harmfulness to the human body. Therefore, it is imperative that an orthodontic wire, which is harmless to the human body, should be provided.

### DISCLOSURE

### Technical Problem

The present invention is conceived to solve the problems in the prior art. An object of the present invention is to provide an orthodontic wire, which is capable of continuously holding the color of teeth and is not harmful to the human body, and a manufacturing method of the orthodontic wire.

### Technical Solution

According to an aspect of the present invention for achieving the objects, there is provided an orthodontic wire, comprising a metal wire formed of a metal alloy material; a silver (Ag) film applied to a surface of the metal wire; and a polymer compound film applied to a surface of the silver (Ag) film to prevent the silver (Ag) film from being discolored.

A silane-based adhesion promoting film may be further provided between the silver (Ag) film and the polymer compound film.

According to another aspect of the present invention, there is provided an orthodontic wire, comprising a metal wire formed of a metal alloy material; a silver (Ag) film applied to a surface of the metal wire; a metal oxide film applied to and formed on a surface of the silver (Ag) film; and a polymer compound film applied to the metal oxide film.

Here, the metal wire may comprise any one of Ni—Ti alloy, stainless steel, Ni—Co alloy, Ni—Cr alloy and Ti alloy.

Also, the polymer compound film may be formed by parylene coating. Preferably, the parylene has a thickness ranged from 0.1 to 100 μm.

In addition, the silver (Ag) film may be is subjected to plasma treatment, thereby improving adhesion property. Preferably, the plasma treatment is performed using any one of argon (Ar), oxygen (O₂), nitrogen (N₂) and mixture thereof as a gas for plasma generation.

The metal oxide may be formed by coating the silver (Ag) film with any one of ITO, ZnO, TiO₂, Al₂O₃, Ta₂O₅, ZrO₂, GeO₂, Y₂O₃, La₂O₃, HfO₂, CaO, In₂O₃, SnO₂, MgO, WO₂ and WO₃. Preferably, the metal oxide has a thickness between 10 Å and 1 μm .

The metal oxide film may be formed by using any one of sputtering, e-beam evaporation, thermal evaporation, ion plating and dipping.

In the meantime, according to a further aspect of the present invention, there is provided a method for manufacturing an orthodontic wire, comprising the steps of manufacturing a metal wire of shape memory alloy; coating a surface of the manufactured metal wire with a silver (Ag) film; and coating a surface of the silver (Ag) film with parylene to form a polymer compound film.

The method may further comprise a pretreatment step for improving adhesive property between the silver (Ag) film and the polymer compound film before coating the silver (Ag) film with parylene. Preferably, the pretreatment step comprises a cleaning process and an AP (adhesion promotion) process of the surface of the silver (Ag) film.

In addition, the method may further comprise a plasma treatment step for improving adhesive property of the polymer compound film to the silver (Ag) film.

In the meantime, according to a further aspect of the present invention, there is provided a method for manufacturing an orthodontic wire, comprising the steps of manufacturing a metal wire of shape memory alloy; coating a surface of the manufactured metal wire with a silver (Ag) film; coating a surface of the silver (Ag) film with a metal oxide to form a metal oxide film; and coating a surface of the metal oxide film with parylene to form a polymer compound film.

Here, the silver (Ag) film may be formed using any one of thermal evaporation, ion plating, chemical vapor deposition, plasma deposition and plating.

In addition, the parylene coating may comprise at least one of C(di-chloro-para-xylene)-type dimer, N(di-para-xylene)-type dimer, D(tetra-chloro-para-xylene)-type dimer and F(octafluoro-[2,2]para-xylene)-type dimer.

Further, the step of coating the silver (Ag) film with parylene may comprise the steps of vaporizing the dimer at a temperature of 100 to 250° C. in a vaporizer, passing the vaporized dimer through an electric pyrolysis furnace of a temperature of 550 to 750° C. to pyrolyze the vaporized dimer into monomers, and depositing the monomers on a surface of the metal wire while maintaining a partial pressure of the monomers in a range of 10 to 100 mTorr.

The method may further comprise the step of heat treating the wire after coating the surface of the metal oxide film with parylene to form the polymer compound film.

Also, the heat treatment may be performed at a temperature between 50° C. and 400° C. for 1 minute to 48 hours.

### ADVANTAGEOUS EFFECTS

According to an orthodontic wire and a manufacturing method thereof according to the present invention, there are advantages in that by coating the silver (Ag) film with parylene after coating an orthodontic wire with a silver (Ag) film, silver with the color of teeth is prevented from being discolored and disgust can be reduced since the or thodontic wire gives a sense of integration with teeth while the orthodontic wire is put on the teeth.

In addition, there is an advantage in that the orthodontic wire can give further improved fit to the teeth since the wire is harmless to the human body and feels good to the touch by coating the outermost surface of the wire with parylene.

### DESCRIPTION OF THE DRAWINGS

FIG. 1 shows a schematic view and a sectional view of a conventional orthodontic wire;

FIG. 2 shows a schematic view and a sectional view of an orthodontic wire according to an embodiment of the present invention; and

FIG. 3 shows a schematic view and a sectional view of an orthodontic wire according to another embodiment of the present invention.

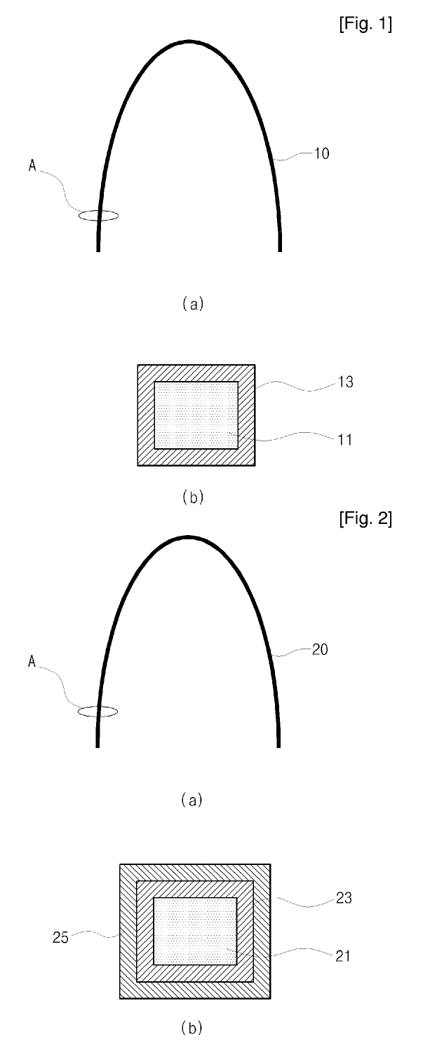

### BEST MODE

Hereinafter, preferred embodiments and operation of an orthodontic wire and a manufacturing method thereof according to the present invention will be described with reference to the accompanying drawings.

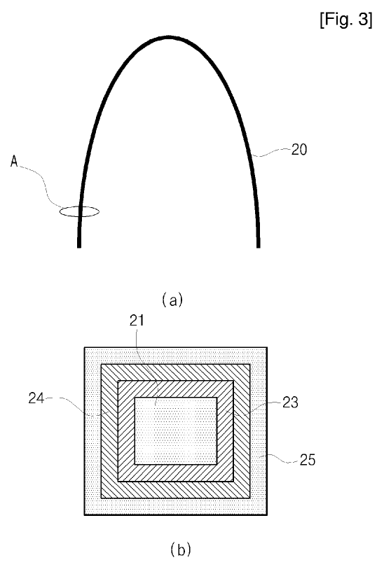

FIG. 2 shows a schematic view and a sectional view of an orthodontic wire according to a first embodiment of the present invention, and FIG. 3 shows a schematic view and a sectional view of an orthodontic wire according to a second embodiment of the present invention. The orthodontic wires shown in FIGS. 2 and 3 are structurally different from each other in that the orthodontic wire shown in FIG. 3 further comprises a metal oxide film 23.

As shown in FIG. 2 (a) and FIG. 3 (a), an orthodontic wire 20 is externally similar to an ordinary wire. However, since the orthodontic wire 20 is internally different from an ordinary wire, a shape and a manufacturing process of the orthodontic wire 20 will be described with reference to FIG. 2 (b) and FIG. 3 (b).

FIG. 2 (b) is a sectional view of a portion A of the orthodontic wire shown in FIG. 2 (a) for describing the first embodiment of the present invention.

As shown in FIG. 2 (b), the orthodontic wire 20 according to the first embodiment of the present invention comprises a metal wire 21 formed to extend, a silver (Ag) film 23 applied to the surface of the metal wire 21, and a polymer compound film 25 applied to the surface of the silver (Ag) film 23.

The orthodontic wire according to the first embodiment of the present invention further comprises a silane-based adhesion promoting film provided between the silver film 23 and the polymer compound film 25 in order to improve adhesion therebetween.

In the meantime, FIG. 3 (b) is a sectional view of a portion A of the orthodontic wire shown in FIG. 3 (a) for describing the second embodiment of the present invention.

As shown in FIG. 3 (b), the orthodontic wire 20 according to the second embodiment of the present invention comprises a metal wire 21 formed to extend, a silver (Ag) film 23 applied to the surface of the metal wire 21, a metal oxide film 24 formed by coating the surface of the silver film 23 with metal oxide, and a polymer compound film 25 applied to the surface of the metal oxide film 24.

Furthermore, in the first embodiment and the second embodiment of the present invention, it is preferable that plasma treatment be performed on the silver film 23 in order to improve the adhesive property of the polymer compound film 25 or the metal oxide film 24 applied to the surface of the silver film 23. Although the kind of a plasma generating gas used to perform the plasma treatment on the silver film 23 may vary according to predetermined processing conditions, it is preferable that any one of argon (Ar), oxygen (O₂) and nitrogen (N₂), or a mixed gas of at least two thereof.

The metal wire 21 according to the first and second embodiments of the present invention is made of metal alloy including an ordinary metal material and a shape memory alloy material. A metal alloy material for the metal wire 21 preferably comprises any one of Ti—Ni alloy, stainless steel, Ni—Co alloy, Ni—Cr alloy and Ti alloy.

An ordinary metal is not restored to its original shape although it is heated or cooled if the ordinary metal is deformed beyond its elasticity limit. However, there are alloys that are restored to their originally formed shapes if the deformed alloys are heated again after forming the alloys in a proper shape at high temperature and deforming the formed alloys at room temperature.

This is referred to as a shape memory effect, which occurs since the alloys memorize given shapes as atomic configurations. The effect appears not by diffusion, but in alloys transformed, wherein after a parent phase atomic configuration of a high temperature is memorized even during transformation at low temperature, the parent phase atomic configuration is reconfigured as its original atomic configuration when it becomes a high temperature again.

This effect generates a large force at the same time when the shape of the shape memory alloy is restored. Since such a force is generated from the shape memory alloy, the shape memory alloy is used as a sensing element as well as used for fastening mechanical parts. Therefore, a metal wire made of shape memory alloy material can be used for correcting teeth.

The silver (Ag) film 23 applied to the surface of the metal wire 21 formed of the shape memory alloy material and an ordinary alloy material is applied to the surface of the metal wire 21 in order to represent a color similar to that of teeth. The silver films 23 according to the first and second embodiments of the present invention are formed by any one of thermal evaporation, ion plating, chemical vapor deposition, plasma deposition, and plating using silver (Ag).

The polymer compound film 25 formed on the surface of the silver film 23 (in case of the first embodiment of the present invention, referring to FIG. 2) or the metal oxide film 24 (in case of the second embodiment of the present invention, referring to FIG. 3) is applied in order to prevent the silver film 23 from being discolored. The polymer compound film 25 is formed by coating the surface of the silver film 23 or the metal oxide film 24 with parylene.

The parylene applied to the surface of the silver film 23 (in case of the first embodiment of the present invention, referring to FIG. 2) or the metal oxide film 24 (in case of the second embodiment of the present invention, referring to FIG. 3) is prefer ably formed in a thickness range between 0.1 μm and 100 μm.

Since the parylene, which is a material verified to be harmless to the human body, is capable of uniformly applying to the surface of the silver film 23, has good surface roughness, and feels soft, the parylene allows the orthodontic wire to feel good to the touch when the orthodontic wire coated with the parylene is attached to the teeth.

Meanwhile, in a first embodiment of the present invention, it is preferable that a silane-based adhesion promoting film (not shown) is additionally provided between the polymer compound film 25 and the silver film 23 in order to improve the adhesive property between the silver film 23 and a polymer compound film 25 formed by applying the parylene. The adhesive property between the silver film 23 and the polymer compound film 25 is enhanced by an action between the silane-based adhesion promoting film and the polymer compound film 25.

In the first and second embodiments of the present invention, it is preferable that plasma treatment be additionally performed on the silver film 23 in order to improve the adhesive property between the polymer compound film 25 and the silver film 23.

In the meantime, referring to the configuration of the orthodontic wire according to the second embodiment of the present invention (see FIG. 3 (b)), the metal oxide film 24 is included between the silver film 23 and the polymer compound film 25, wherein the metal oxide film is formed by coating the silver (Ag) film with any one of ITO, ZnO, TiO₂, Al₂O₃, Ta₂O₅, ZrO₂, GeO₂, Y₂O₃, La₂O₃, HfO₂, CaO, In₂O₃, SnO₂, MgO, WO₂ and WO₃.

The metal oxide film 24 applied to and formed on the surface of the silver film 23 preferably has a thickness range between 10 Å and 1 μm. Any one of sputtering, e-beam evaporation, thermal evaporation, ion plating and dipping is preferably used to form the metal oxide film 24 having the thickness range.

Manufacturing methods of the orthodontic wires according to the first and second embodiments of the present invention so constructed will be described as follows.

First, according to the first and second embodiments of the present invention, the metal wire 21 is made of any one of metal alloy materials including Ti—Ni alloy, stainless steel, Ni—Co alloy, Ni—Cr alloy and Ti alloy. The metal wire 21 has elastic and tensile properties.

Once the metal wire 21 is manufactured, the silver film 23 is applied to the surface of the metal wire 21 in the first and second embodiments of the present invention. The silver film 23 is formed using any one of thermal evaporation, ion plating, chemical vapor deposition, plasma deposition and plating using silver. The silver film 23 is formed on the surface of the metal wire 21, so that the orthodontic wire 20 represents the color of teeth.

After coating the surface of the metal wire 21 with the silver film 23, in the process according to the first embodiment of the present invention, the surface of the silver film 23 is coated with parylene to form the polymer compound film 25, as in the structure shown in FIG. 2 (b). The polymer compound film 25 is formed by the parylene coating, so that the silver film 23 is prevented from being discolored and the orthodontic wire that is harmless to the human body can be formed.

In the meantime, according to the first embodiment of the present invention, it is preferred that a predetermined pretreatment process for improving the adhesive property between the silver film 23 and the polymer compound film 25 be performed before coating the surface of the silver film with the parylene for forming the polymer compound film 25.

The pretreatment process according to the first embodiment of the present invention comprises a process of cleaning the surface of the silver film 23 to modify the surface thereof and an AP (adhesion promotion) process of forming an adhesion promoting film (not shown) on the surface of the silver film 23.

The adhesion promoting film is formed by coating the surface of the silver film 23 with a silane-based material in a vacuum state. Additionally, the plasma treatment process can be performed on the silver film 23 to further improve the adhesive property of the polymer compound film 25 to the silver film 23.

In the meantime, according to the manufacturing method of the orthodontic wire of the second embodiment of the present invention, as shown in (b) of FIG. 3, the polymer compound film 25 is not applied directly to the surface of the silver film 23, but the metal oxide film 24 is formed by coating the surface of the silver film 23 with metal oxide. Then, the polymer compound film 25 is formed by coating the surface of the metal oxide film 24 with parylene. In the meantime, before the surface of the silver film 23 is coated with the metal oxide film 24, the adhesive property of the metal oxide film 24 to the silver film 23 can be further improved by performing the plasma treatment on the silver film 23.

The metal oxide film applied to the surface of the silver film 23 is formed by coating the silver (Ag) film with any one of ITO, ZnO, TiO₂, Al₂O₃, Ta₂O₅, ZrO₂, GeO₂, Y₂O₃, La₂O₃, HfO₂, CaO, In₂O₃, SnO₂, MgO, WO₂ and WO₃. The metal oxide film 24 applied to and formed on the surface of the silver film 23 preferably has a thickness range between 10 Å and 1 μm. Any one of sputtering, e-beam evaporation, thermal evaporation, ion plating and dipping is preferably used to form the metal oxide film 24 having the thickness range.

The parylene coating, which is performed according to the first and second embodiments of the present invention, preferably comprises C(di-chloro-para-xylene)-type dimer, N(di-para-xylene)-type dimer, D(tetra-chloro-para-xylene)-type dimer, F(octafluoro-[2,2]para-xylene)-type dimer, and a mixed dimer of at least two thereof.

A method for the parylene coating will simply be described as follows. First, at least one dimer is vaporized to a temperature of 100 to 250° C. in a vaporizer. The vaporized dimer is pyrolyzed into monomers by passing the vaporized dimer through an electric pyrolysis furnace at a temperature of 550 to 750° C. Then, a partial pressure of the monomers is maintained in a range of 10 to 100 mTorr in a vacuum chamber, and the metal wire is coated with parylene in a polymer state by depositing the monomers on the surface of the metal wire.

Meanwhile, according to a second embodiment of the present invention, once the polymer compound film is formed by coating the surface of the metal oxide film 24 with parylene and thus the orthodontic wire is manufactured, the step of heat treating the orthodontic wire may be further comprised. The heat treatment causes the bonding force between the respective components of the orthodontic wire to be enhanced, thereby improving the general strength of the wire. The heat treatment is preferably performed at a temperature of 50 to 400° C. for 1 minute to 48 hours.

The present invention is not limited to the embodiments disclosed above, but can be embodied in a variety of aspects. The aforementioned embodiments are provided only for the purposes of completely illustrating the present invention as well as causing the technical spirit and scope of the present invention to be understood by those skilled in the art.

1. An orthodontic wire, comprising:
a metal wire formed of a metal alloy material;
a silver (Ag) film applied to a surface of the metal wire; and
a polymer compound film applied to a surface of the silver (Ag) film to prevent the silver (Ag) film from being discolored.

2. An orthodontic wire, comprising:
a metal wire formed of a metal alloy material;
a silver (Ag) film applied to a surface of the metal wire;
a metal oxide film applied to and formed on a surface of the silver (Ag) film; and
a polymer compound film applied to the metal oxide film.

3. The orthodontic wire as claimed in claim 1, wherein a silane-based adhesion promoting film is further provided between the silver (Ag) film and the polymer compound film.

4. The orthodontic wire as claimed in claim 3, wherein the metal wire comprises any one of Ni—Ti alloy, stainless steel, Ni—Co alloy, Ni—Cr alloy and Ti alloy.

5. The orthodontic wire as claimed in claim 3, wherein the polymer compound film is formed by parylene coating.

6. The orthodontic wire as claimed in claim 5, wherein the parylene has a thickness ranged from 0.1 to 100 μm.

7. The orthodontic wire as claimed in claim 3, wherein the silver (Ag) film is subjected to plasma treatment, thereby improving adhesion property.

8. The orthodontic wire as claimed in claim 7, wherein the plasma treatment is performed using any one of argon (Ar), oxygen (O₂), nitrogen (N₂) and mixture thereof as a gas for plasma generation.

9. The orthodontic wire as claimed in claim 2, wherein the metal oxide film is formed by coating the silver (Ag) film with any one of ITO, ZnO, TiO₂, Al₂O₃, Ta₂O₅, ZrO₂, GeO₂, Y₂O₃, La₂O₃, HfO₂, CaO, In₂O₃, SnO₂, MgO, WO₂ and WO₃.

10. The orthodontic wire as claimed in claim 9, wherein the metal oxide film has a thickness between 10 Å and 1 μm.

11. The orthodontic wire as claimed in claim 10, wherein the metal oxide film is formed by using any one of sputtering, e-beam evaporation, thermal evaporation, ion plating and dipping.

12. A method for manufacturing an orthodontic wire, comprising the steps of:
manufacturing a metal wire of shape memory alloy;
coating a surface of the manufactured metal wire with a silver (Ag) film; and
coating a surface of the silver (Ag) film with parylene to form a polymer compound film.

13. A method for manufacturing an orthodontic wire, comprising the steps of:
manufacturing a metal wire of shape memory alloy;
coating a surface of the manufactured metal wire with a silver (Ag) film;
coating a surface of the silver (Ag) film with a metal oxide to form a metal oxide film; and
coating a surface of the metal oxide film with parylene to form a polymer compound film.

14. The method as claimed in claim 12, further comprising a pretreatment step for improving adhesive property between the silver (Ag) film and the polymer compound film before coating the silver (Ag) film with parylene.

15. The method as claimed in claim 14, wherein the silver (Ag) film is formed using any one of thermal evaporation, ion plating, chemical vapor deposition, plasma deposition and plating.

16. The method as claimed in claim 14, wherein the pretreatment step comprises a cleaning process and an AP (adhesion promotion) process of the surface of the silver (Ag) film.

17. The method as claimed in claim 12, further comprising a plasma treatment step for improving adhesive property of the polymer compound film to the silver (Ag) film.

18. The method as claimed in claim 12, wherein the parylene coating comprises at least one of C(di-chloro-para-xylene)-type dimer, N(di-para-xylene)-type dimer, D(tetra-chloro-para-xylene)-type dimer and F(octafluoro-[2,2]para-xylene)-type dimer.

19. The method as claimed in claim 18, wherein the step of coating the silver (Ag) film with parylene comprises the steps of vaporizing the dimer at a temperature of 100 to 250° C. in a vaporizer, passing the vaporized dimer through an electric pyrolysis furnace of a temperature of 550 to 750° C. to pyrolyze the vaporized dimer into monomers, and depositing the monomers on a surface of the metal wire while maintaining a partial pressure of the monomers in a range of 10 to 100 mTorr.

20. The method as claimed in claim 13, further comprising the step of heat treating the wire after coating the surface of the metal oxide film with parylene to form the polymer compound film.

21. The method as claimed in claim 20, wherein the heat treatment is performed at a temperature between 50° C. and 400° C. for 1 minute to 48 hours.
